(19) United States
(12) Patent Application Publication
(10) Pub. No.: US 2010/0225954 A1
(43) Pub. Date: Sep. 9, 2010

(54) JOB SCHEDULE GENERATION

(76) Inventor: Marcello Balduccini, Penfield, NY (US)

Correspondence Address: Raymond L. Owens;Patent Legal Staff, Eastman Kodak Company, 343 State Street, Rochester, NY, 14650-2201, US

(21) Appl. No.: 12/396,640

(22) Filed: Mar. 3, 2009

(51) Int. Cl. G06F 3/12

(52) U.S. Cl. 358/1.15

(57) ABSTRACT

In some embodiments, job schedules are generated from an answer set or a derivative thereof at least by executing an answer-set program, the answer set including a set of constraints, and the answer-set program indicating, among other things, a set of jobs. The job schedules are stored in a processor-accessible memory system.

### FIELD OF THE INVENTION

This invention relates to generating job schedules by solving job scheduling problems.

### BACKGROUND OF THE INVENTION

Solving job scheduling problems is a difficult task for humans because of the number of alternatives that must be considered in the search for a solution. Various programming techniques have been devised to allow using computers to solve scheduling problems. Most of these techniques work well when the problem is relatively simple (e.g. when the jobs can be processed by any of the devices available). However, when the problem becomes more complex, traditional programming techniques lose their effectiveness. For example, generating job schedules for printing workflows is complex because such workflows include a number of constraints, such that certain jobs can be processed only by particular devices at particular times, some jobs must be processed before others, and a user prefers solutions of a certain kind over others. Conventional techniques, such as constraint logic programming, require complex programs and elaborate and time-consuming executions to solve complex scheduling problems such as these, due to their relatively low level of abstraction.

In recent years, powerful declarative languages have been designed that allow solving industrial-size problems by programming at a higher level of abstraction. Programmers using such declarative languages essentially describe the problems and the properties of the desired solutions, and let general-purpose programs, called solvers, find the solutions satisfying the given constraints. It is important to stress that the programmer no longer specifies how to compute the solution—the solver, when executed by a data processing system, takes care of that.

Most declarative languages have so far been focused on either quantitative problems (e.g. finding solutions to sets of sophisticated equations) or qualitative problems (e.g. determining how to perform discrete actions on a physical system, such as an electrical circuit, to obtain a certain macroscopic effect, such as lighting certain bulbs), but not both. Among the most promising languages (and related programming methodologies) are constraint satisfaction—which allows describing equations and inequalities among variables of interest—and answer set programming (ASP)—which allows describing the properties of objects and the relations among them using a simple logical language. The phrase “basic ASP”, as used herein, refers to a basic definition of the syntax and semantics of the language of ASP, where an answer set program is a set of rules, and a rule is a statement of the form:

h←l₁, . . . , lₘ, not lₘ₊₁, . . . , not lₙ (1)

where h and lᵢ's are first order literals and not is the so-called default negation, known in the art. For more details, see the definitions provided by Michael Gelfond and Vladimir Lifschitz in the article “Classical negation in logic programs and disjunctive databases”, New Generation Computing (1991) pp. 365-385.

Constraint satisfaction has been shown to provide elegant solutions to industrial-size problems whose nature is mostly quantitative. Answer set programming has been used to solve industrial-size problems whose nature is mostly qualitative.

Certain complex scheduling problems, such as those for the printing workflow, on the other hand, involve both quantitative aspects (e.g. the start times of execution of the jobs) and qualitative aspects (e.g. required order of execution among jobs, preferences for solutions having certain properties). Some early attempts have been made at solving scheduling problems by combining answer set programming and constraint satisfaction. However, such techniques are hardly applicable to practical, industrial-size problems. In fact, they depend on ad-hoc solvers, some of which having relatively limited capabilities. Solving scheduling problems for these complex scheduling problems, such as printing workflow, requires instead the use of advanced solvers, some of which commercial, and the ability to move to a different solver as the application evolves.

Consequently, a need exists for a method of solving scheduling problems in general, and those related to the printing workflow, in particular, by combining answer set programming and constraint satisfaction in such a way that allows using off-the-shelf solvers interchangeably and without modifications to the solvers.

### SUMMARY

The above-described problems are addressed and a technical solution is achieved in the art by a system and a method for generating job schedules, according to various embodiments of the present invention. In an embodiment of the present invention, job schedules are generated from an answer set or a derivative thereof at least by executing an answer-set program, the answer set including a set of constraints, and the answer-set program indicating, among other things, a set of jobs. The job schedules are stored in a processor-accessible memory system.

In some embodiments, the answer set is a program suitable for execution by a constraint solver. In other embodiments, a constraint program is generated at least from the answer set, the constraint program suitable for execution by a constraint solver. The constraint solver can be a constraint solver embedded in SICStus Prolog.

In some embodiments, the answer-set program further indicates rules for interactions between jobs and allocation of jobs. In some embodiments, the answer-set program is executed using at least a set of relations. The set of relations can include cspdomain with arity 1, cspvar with arity 3, required with arity 1. In some embodiments, the answer-set program indicates a set of offset printing jobs.

In some embodiments of the present invention, the set of jobs include at least one job part for each job in the set of jobs. The job schedules indicate an assignment of a start time to each of the job parts, each start time indicating a time on which the job part is to begin being executed by a job-processing resource.

In some embodiments, a plurality of answer sets are generated at least by executing the answer-set program. Each answer set includes a set of constraints, and the job schedules are generated for the set of jobs at least by executing at least one of the answer sets or derivatives thereof.

In some embodiments, the answer set program is executed by an answer set solver, and the answer set or derivative thereof is executed by a constraint solver.

In some embodiments, the answer set program conforms to basic, non-extended, answer-set programming.

In addition to the embodiments described above, further embodiments will become apparent by reference to the drawings and by study of the following detailed description.

### BRIEF DESCRIPTION OF THE DRAWINGS

The present invention will be more readily understood from the detailed description of exemplary embodiments presented below considered in conjunction with the attached drawings, of which:

FIG. 1 illustrates a data processing system and its interfacing components, according to an embodiment of the present invention;

FIG. 2 illustrates a method for generating a job schedule, according to an embodiment of the present invention;

FIG. 3 illustrates an expansion of step S9 of FIG. 2, according to an embodiment of the present invention;

FIG. 4 illustrates an expansion of step S9-5 of FIG. 3, according to an embodiment of the present invention; and

FIG. 5 illustrates an expansion of step R6 of FIG. 4, according to an embodiment of the present invention.

It is to be understood that the attached drawings are for purposes of illustrating the concepts of the invention and may not be to scale.

### DETAILED DESCRIPTION

In the following description, embodiments of the present invention often are described as a software program. Those skilled in the art will readily recognize that the equivalent of such software may also be constructed in hardware or firmware.

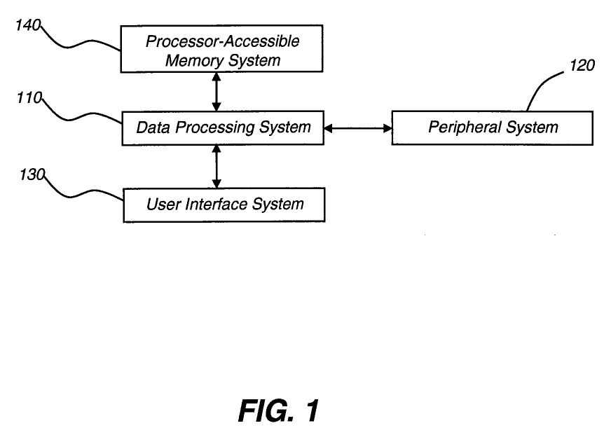

FIG. 1 illustrates a system 100 for implementing the various embodiments of the present invention. The system 100 includes a data processing system 110, a peripheral system 120, a user interface system 130, and a processor-accessible memory system 140. The processor-accessible memory system 140, the peripheral system 120, and the user interface system 130 are communicatively connected to the data processing system 110.

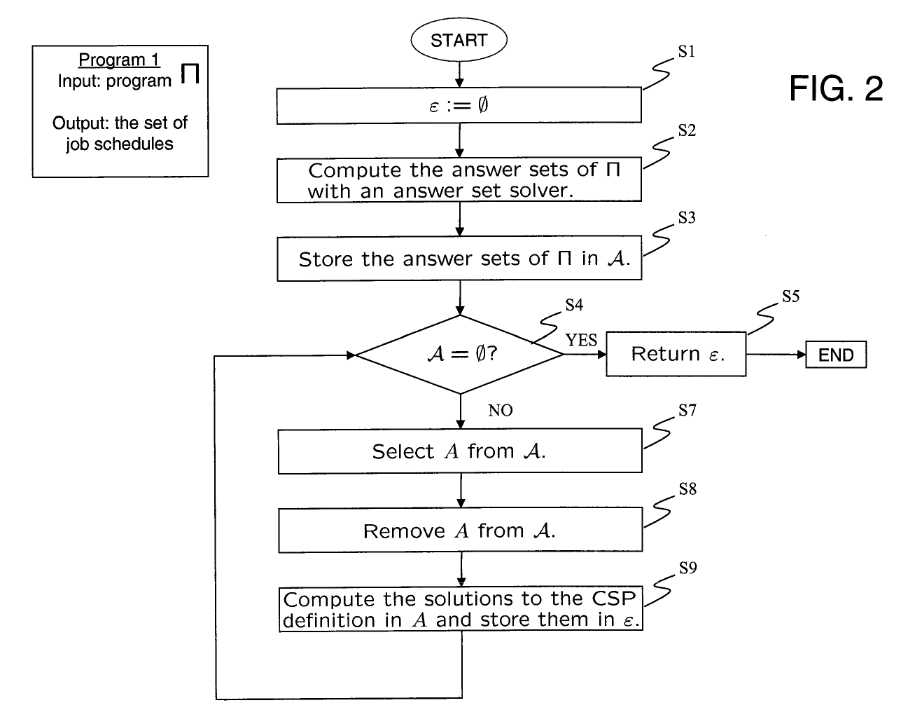

The data processing system 110 includes one or more data processing devices that implement the processes of the various embodiments of the present invention, including the example processes of FIGS. 2-5. The phrases “data processing device” or “data processor” are intended to include any data processing device, such as a central processing unit (“CPU”), a desktop computer, a laptop computer, a mainframe computer, a personal digital assistant, a Blackberry™, a digital camera, cellular phone, or any other device or component thereof for processing data, managing data, or handling data, whether implemented with electrical, magnetic, optical, biological components, or otherwise.

The processor-accessible memory system 140 includes one or more processor-accessible memories configured to store information, including the information needed to execute the processes of the various embodiments of the present invention, including the example processes of FIGS. 2-5 described herein. The processor-accessible memory system 140 may be a distributed processor-accessible memory system including multiple processor-accessible memories communicatively connected to the data processing system 110 via a plurality of computers and/or devices. On the other hand, the processor-accessible memory system 140 need not be a distributed processor-accessible memory system and, consequently, may include one or more processor-accessible memories located within a single data processor or device.

The phrase “processor-accessible memory” is intended to include any processor-accessible data storage device, whether volatile or nonvolatile, electronic, magnetic, optical, or otherwise, including but not limited to, registers, floppy disks, hard disks, Compact Discs, DVDs, flash memories, ROMs, and RAMs.

The phrase “communicatively connected” is intended to include any type of connection, whether wired or wireless, between devices, data processors, or programs in which data may be communicated. Further, the phrase “communicatively connected” is intended to include a connection between devices or programs within a single data processor, a connection between devices or programs located in different data processors, and a connection between devices not located in data processors at all. In this regard, although the processor-accessible memory system 140 is shown separately from the data processing system 110, one skilled in the art will appreciate that the processor-accessible memory system 140 may be stored completely or partially within the data processing system 110. Further in this regard, although the peripheral system 120 and the user interface system 130 are shown separately from the data processing system 110, one skilled in the art will appreciate that one or both of such systems may be stored completely or partially within the data processing system 110.

The user interface system 130 may include a mouse, a keyboard, another computer, or any device or combination of devices from which data is input to the data processing system 110. In this regard, although the peripheral system 120 is shown separately from the user interface system 130, the peripheral system 120 may be included as part of the user interface system 130.

The user interface system 130 also may include a display device, a processor-accessible memory, or any device or combination of devices to which data is output by the data processing system 110. In this regard, if the user interface system 130 includes a processor-accessible memory, such memory may be part of the processor-accessible memory system 140 even though the user interface system 130 and the processor-accessible memory system 140 are shown separately in FIG. 1.

FIG. 2 illustrates how the job schedules for a given problem are computed according to an embodiment of the present invention. The data processing system 110, when executing the process illustrated by FIG. 2, takes as input an answer set program indicating a set of jobs and describing the scheduling problem associated therewith, and executes the answer set program using an answer set solver, thereby generating one or more answer sets. The answer set program is written according to the practices known to the people skilled in the art, with the following stipulations:

An expression of the form cspdomain( [symbol] ) means that [symbol] is the numerical domain to be used in solving the problem. For example, cspdomain(f d) says that the numerical domain is that of finite domains (i.e. integer numbers). Depending on the numerical domain selected, a suitable constraint satisfaction solver is selected.

An expression of the form cspvar(v, l, u) means that v is a numerical variable ranging over [l, u].

An expression of the form required(γ) means that γ is required to hold, where γ is an expression (also called a constraint) over one or more numerical variables declared by the cspvar expressions (in the following discussion, we will call these variables simply numerical variables). In particular, γ can be of two forms: (i) an e-constraint, that is an equality or inequality over the numerical variables (e.g. required(x≧y+1) says that inequality x≧y+1 must hold); (ii) a g-constraint, that is a global constraint from the language of the constraint satisfaction solver used; global constraints are expressions over sets of variables, whose syntax and meaning depend on the solver. For example, in the constraint solver embedded in the SICStus Prolog system, the global constraint cumulative([x, y], [1, 2], [1, 1], 1) means that the values of variables x and y must be selected so that either y≧x+1 or x≧y+2 (more information about this can be found in the documentation of SICStus Prolog, known in the art). Notice that the expression [x, y] denotes a list of variables. To allow for a convenient specification of lists of variables that are represented in functional format (for example, v(1), v(2), v(3) are all numerical variables built from function v), as well as of list of constants, γ is allowed to contain short-hands of the form [f/k], interpreted as follows. If numerical variables built from function f and with k arguments (that is, with arity k) have been declared, then [f/k] is interpreted as a shorthand for the list of all variables formed from that function symbol and with that number of arguments, ordered lexicographically. For example, if f(1), f(2), f(3) are numerical variables, the expression [f/1] is a shorthand for the list [f(1), f(2), f(3)]. If no numerical variables have been declared with function symbol and arity matching the specification in the expression [f/k], then the expression is interpreted as a shorthand for the list [symbol] e₁, e₂, . . . , eₙ [symbol] , where eᵢ is the last element of one of the tuples satisfying relation f with arity k, and where the list is ordered according to the lexicographic ordering of the tuples. For example, given a relation r defined by r(a, 3), r(b, 1), r(c, 2) (that is, by tuples [symbol] a, 3 [symbol] , [symbol] b, 1 [symbol] , [symbol] c, 2 [symbol] ), the expression [r/2] is a shorthand for the list [3, 1, 2].

The answer set program is written using usual techniques known in the art so that, once executed by a suitable solver by data processing system 110, its answer sets contain a set of constraints, encoded by expressions formed by relations cspdomain, cspvar and required.

For example, consider the answer set program that solves the following simple scheduling problem. One skilled in the art will recognize, however, that embodiments of the present invention can be promptly extended to more complex scenarios. In offset printing, a job (e.g., the production of a book) consists of various parts, corresponding to the various stages of the production (e.g., printing, binding, etc.). The basic scheduling problem in this example consists of finding start times for the processing of each job part of each job, so that all the parts of all jobs can be processed by the same machine (or resource), without overlap. The association of start times must also take into account the required order of execution among the various job parts. For example, binding must always occur after printing.

For this example, assume there are two jobs, book1 and book2. Job book1 consists of two parts, print and bind, while job book2 consists of three parts, print, fold, bind. Printing and binding of book1 takes 3 and 2 time units, respectively. Printing, folding, and binding of book2 takes 4, 8, and 1 time units, respectively. Printing must precede binding for book1. Printing must precede folding, which must precede binding, for book2. The data processing system 110 is required to find a start time for each job's part so that they can all be processed on the same machine, without overlap.

The start time of each job part is denoted by a numerical variable of the form st(j, p) indicating the start time of a job j and one of its parts p. For example, st(book1, bind) indicates a time on which the binding phase (a job part of job book1) is to begin being executed by a job-processing resource. Suppose that the start times range between 0 and 200 time units. The following e-constraint st(j, p2)≧st(j, p1)+Len1 ensures that the ordering of the parts is enforced. In particular, this example e-constraint requires, for every two parts p1, p2 of every job j, that p1 precedes p2 (Len1 denotes the length of part p1).

The answer set program that solves this example scheduling problem is shown below.

TABLE 1

| | |
|---|---|
| 1. | job(book1). job(book2). |
| 2. | job_part(book1, print). job_part(book1, bind). |
| 3. | job_part(book2, print). job_part(book2, fold). |
| 4. | job_part(book2, bind). |
| 5. | part_len(book1, print, 3). part_len(book1, bind, 2). |
| 6. | part_len(book2, print, 4). part_len(book2, fold, 8). part_len(book2, bind, 1). |
| 7. | precedes(book1, print, bind). |
| 8. | precedes(book2, print, fold). precedes(book2, fold, bind). |
| 9. | cspdomain(fd). |
| 10. | cspvar(st(J, P), 0, 200) ← |
| 11. | job(J), job_part(J, P). |
| 12. | required( st(J, P2) ≧ st(J, P1) + Len1 ) ← |
| 13. | job(J), |
| 14. | job_part(J, P1), job_part(J, P2), |
| 15. | precedes(J, P1, P2), |
| 16. | part_len(J, P1, Len1). |
| 17. | part_res(J, P, 1) ← |
| 18. | job(J), job_part(J, P). |
| 19. | required(cumulative([st/2], [part_len/3], [part_res/3], 1)). |

Line 1 of the program, above, defines a set of jobs, book1 and book2. Lines 2-6 and 17-18 define the jobs' parts, as well as their lengths and the resources each requires. Lines 7-8 define rules for interactions between jobs and allocation of jobs. Lines 12-16 contain an example of an e-constraint, and line 19 contains an example of a g-constraint. One skilled in the art will appreciate that, although the example shown in Table 1 is configured for a single machine (or resource), embodiments of the present invention extend to multiple machines or resources. Further, it should be noted that the answer set program in Table 1 is written in basic ASP. That is, writing answer set programs that solve job scheduling problems does not require extending the syntax of ASP. Because conventional off-the-shelf answer set solvers support basic ASP, it follows that the present invention can use off-the-shelf answer set solvers. This is a significant advantage over the other existing methods of integrating ASP and constraint satisfaction, which rely on an ad-hoc, extended ASP language and thus require the use of ad-hoc solvers.

As guaranteed by the theory underlying answer set programming, the answer set program in Table 1 has a unique answer set. The answer set includes a set of constraints that are to be used to find a schedule for the scheduling problem. For example, an answer set can contain statements such as cspvar(st(book1, print), 0, 200) and required(st(book1, bind)≧st(book1, print)+3). The first statement states that the job schedule will be represented by numerical variables including st(book1, print), whose value ranges between 0 and 200. The second statement encodes e-constraints to be enforced on numerical variables st(book1, bind) and st(book1, print), that is on the start times of parts bind and print of job book1. Intuitively, the e-constraint says that the bind part of the job must start 3 or more time units after the start of the print part (in the example, 3 is the length of the print part of job book1).

Returning to the process in FIG. 2, the data processing system 110 stores the job schedules for the scheduling problem described by answer set program II in the processor-accessible memory system 140. The set of schedules stored so far in the memory system 140 is denoted here by ε. Initially, ε is set to (S1), as no schedule has been computed yet. Next, an answer set is generated (S2) by executing an answer set program Π, the answer set including a set of constraints, and the answer-set program indicating, among other things, a set of jobs. An off-the-shelf answer set solver can be used to compute the answer sets of Π. Recall that such answer sets include the set of jobs and the constraints on them. According to an embodiment of the present invention, any off-the-shelf answer set solver, such as the powerful SMODELS and DLV solvers, can be used for the computation of the answer sets. The answer sets are then stored in the processor-accessible memory system 140 (S3). Such answer sets are denoted by [symbol] . The data processing system 110 in the rest of the process will select one answer set A of Π at a time, and compute the schedules based on the constraints and job lists from A. To achieve this, the process maintains in [symbol] the answer sets of Π that are still to be processed. Hence, in S4 a check is performed to verify whether there are any answer sets left to process. If there are none, the process returns ε (S5) and terminates. Otherwise, it selects one answer set A from [symbol] (S7) and removes it from [symbol] (S8). The schedules for the job list and constraints included in A are then (S9) computed with a constraint solver and added to ε.

Each job schedule indicates an assignment of a start time to each of the corresponding job parts. For example, if the answer set generated upon execution of the answer-set program of Table 1 is executed by the data processing system 110, the job schedules that would be generated include the following:

### Schedule 1:

st(book1, print)=13, st(book1, bind)=16,
st(book2, print)=0, st(book2, fold)=4, st(book2, bind)=12

### Schedule 2:

st(book1, print)=13, st(book1, bind)=17,
st(book2, print)=0, st(book2, fold)=4, st(book2, bind)=12

Note that there are cases when a scheduling problem admits more than one solution, that is, more than one job schedule. For example, when execution of two jobs can switch arbitrarily without affecting the overall synchronization of jobs, two (or more) schedules (solutions) will exist.

The process then returns to S4, to process any answer sets of II left. It should be noted that the answer set solver and the constraint solver are separately executed independently of each other. Contrary to conventional techniques, the two solvers can be used without needing to be modified to interact with each other, thereby enabling the use of off-the-shelf solvers.

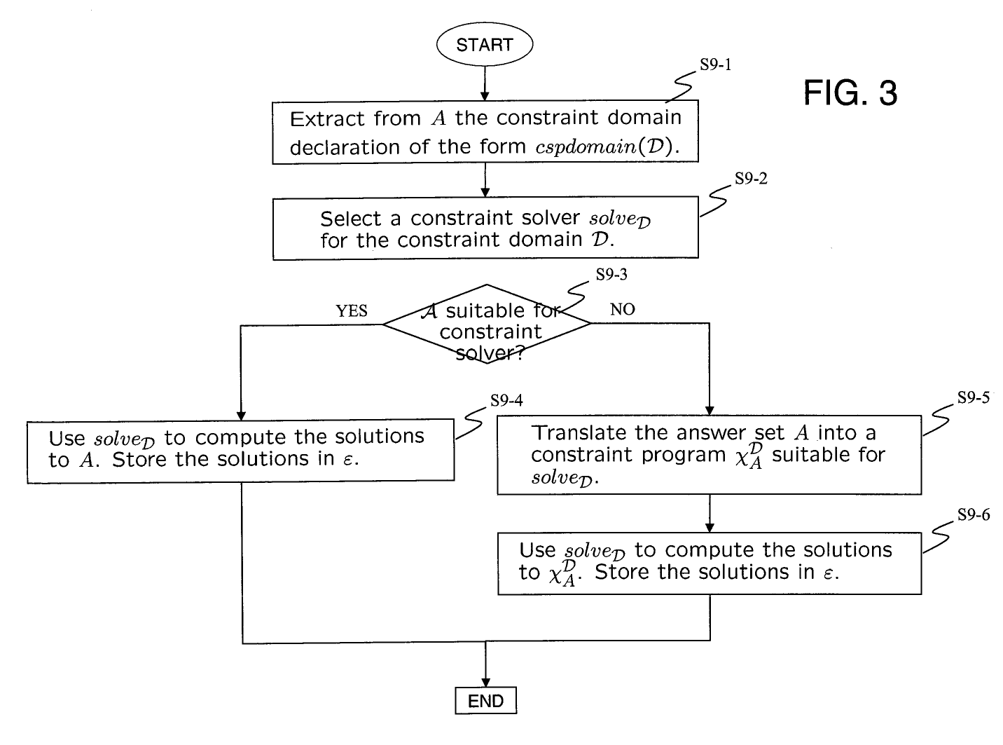

FIG. 3 provides details about step S9 from FIG. 2, according to an embodiment of the present invention. Recall that the purpose of this step is to use a suitable constraint solver to compute the schedules for the job list and constraints included in a given answer set A of answer set program II. The first step (S9-1) consists of extracting from A the expression of the form cspdomain( [symbol] ). Based on the value of argument [symbol] , a suitable constraint solver [symbol] is selected (S9-2), which is capable to solve constraint satisfaction problems over domain [symbol] . Next (S9-3), if A is suitable for execution by the constraint solver [symbol] , i.e., it is in a format acceptable as input to the constraint solver [symbol] , then (S9-4) [symbol] is used to compute the solutions to A and store them in ε. If instead A is not suitable for execution by [symbol] , then (S9-5) a constraint program [symbol] is generated by translating A into a format suitable for execution by constraint solver [symbol] . In this regard, [symbol] can be considered a derivative of A. Also in this regard, (S9-6), [symbol] is run on the generated constraint program [symbol] and the schedules the solver finds are stored in ε.

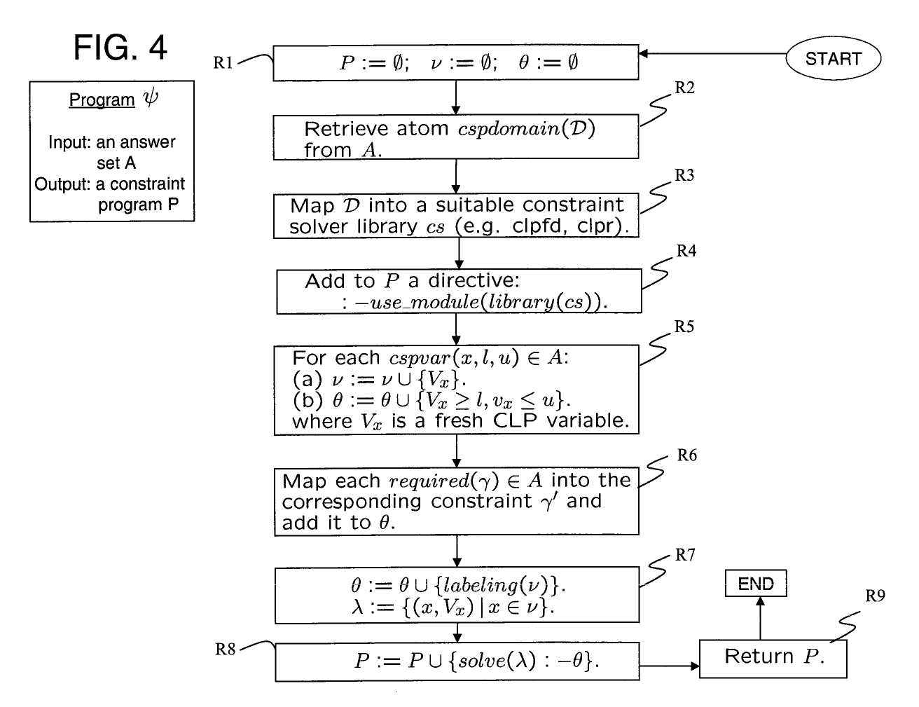

FIG. 4 applies to an embodiment of the present invention where a translation is required between the language that specifies the constraints in answer set A of Π and the input language of the constraint solver selected by the process in FIG. 3. In particular, FIG. 4 shows how the set of constraints from A is translated into a constraint program [symbol] suitable for the constraint solver embedded in SICStus Prolog. Those skilled in the art will readily recognize that the technique applies to the translation for any other constraint solver embedded in a logic programming system, such as SWI-Prolog or GNU-Prolog.

Before describing the process illustrated by FIG. 4, it is helpful to define some terminology. The phrase “target language” means the input language of the constraint solver. The phrase “CLP variables” means the terms of the target language that the numerical variables used in A are mapped to. For example, the numerical variable st(book1, print) can be translated into CLP variable V1.

The process illustrated by FIG. 4 starts by setting variables P, v and θ to (R1). P will eventually contain the constraint program in the target language. As known to those skilled in the art, a constraint program for SICStus Prolog is a set of Prolog clauses (also called rules), each clause containing a head atom and a set of atoms making up the body of the clause. Atoms are formed as in First Order Logic. Constraints among CLP variables are encoded in SICStus Prolog by atoms. For example, V1#>V2 says that the value of V1 must be greater than the value of V2.

v is the set of CLP variables used in P. θ is the set of Prolog atoms that will occur in the main clause of P—the most important of which are the numerical constraints enforced on the CLP variables. At step R2, the data processing system 110 retrieves atom cspdomain( [symbol] ) from A. This is done because the constraint solver embedded in SICStus Prolog supports multiple numerical domains, as long as the appropriate constraint solver library is included in the constraint program. The argument [symbol] is then mapped (R3) into a suitable constraint solver library cs (e.g. clpfd for finite domains, clpr for real numbers). Next (R4), a clause of the form ←use_module(library(cs)) is added to P in order to select the constraint solver library. At step R5, the CLP variables to be used in the encoding are determined. For each declaration of the form cspvar(x, l, u) from A, (a) a fresh CLP variable Vₓ is added to v, and (b) constraints Vₓ≧l and Vₓ≦u are added to θ to define the domain of the CLP variable. Next (R6), each expression of the form required(γ) from A is mapped into a corresponding constraint γ′ and added to θ. Then (R7), the atom labeling(v) is added to θ to instruct the solver to find values for all the CLP variables in v; also, λ is set to the list of pairs (x, Vₓ), thereby explicitly associating each variable from A with the corresponding CLP variable selected at step S5. Finally, the main clause solve(λ)←θ is added to P (R8) and P is returned (R9). Those skilled in the art will promptly notice that there are other ways to write the constraint program. For example, instead of coming up with CLP variables in the process in FIG. 4, one could add to P clauses that generate a list of anonymous Prolog variables, that scans such list to declare all of its elements as CLP variables, and that map at run-time one numerical variable from A to exactly one anonymous CLP variable from the list. Also, statements more sophisticated than labeling(v) could be used to inform the constraint solver of which strategy must be used in assigning values to the CLP variables.

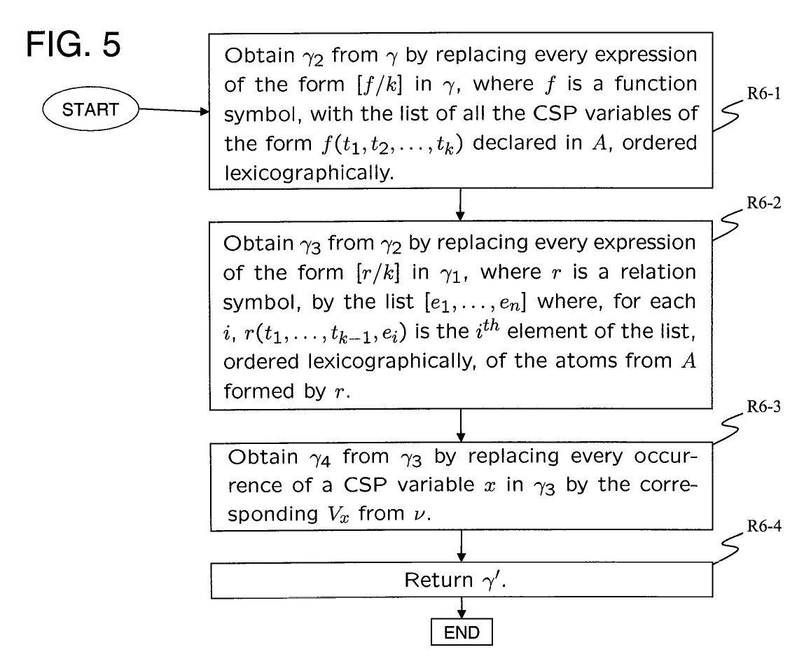

FIG. 5 provides further details on step R6 of FIG. 4, according to an embodiment of the present invention. In particular, FIG. 5 illustrates how an arbitrary statement required(γ) from A can be mapped into a constraint γ′ in the target language. The first step of the process (R6-1) includes processing all short-hands of the form [f/k] in γ. This is obtained by replacing an expression [f/k], where f is a function symbol, with the list, ordered lexicographically, of variables of the form f(t₁, t₂, . . . , tₖ). The result of performing all the replacements on γ is stored in γ₂ (a portion of the processor-accessible memory system 140). The second step (R6-2) performs a similar replacement for the expressions of the form [r/k], where r is a relation symbol. For each such expression from γ₂, the atoms from A of the form r(t₁, . . . , tₖ) are gathered. Then, all the last arguments tₖ are collected and ordered lexicographically in a list [e₁, . . . , eₙ]. The expression [r/k] is then replaced by the list [e₁, . . . , eₙ]. The result of the performing all the replacement on γ₂ is stored in γ₃ (a portion of the processor-accessible memory system 140). Next (R6-3), every numerical variable from γ₃ is replaced by the corresponding CLP variable Vₓ from v. Finally (R6-4), the constraint obtained as the result of the final replacement step is returned.

As discussed earlier, various embodiments of the present invention allow for a compact and intuitive representation of scheduling problems (as an answer set program), and especially those that involve a substantial mix of quantitative and qualitative information, such as the ones from the domain of printing workflow. As an example, compare the answer set program from the previous example with a more traditional implementation based on SICStus Prolog alone (similar results could be obtained with other off-the-shelf systems, such as SWI-Prolog and GNU-Prolog).

Those skilled in the art will recognized that a possible SCIStus Prolog program solving the same problem given an input specified in the same format as for the answer set program is:
:—use_module(library(clpfd)).
:—use_module(library(lists)).
schedule(Vars)
   % determine how many variables we need
   findall((J,P),part_Len(J,P,_),PartList),
   length(PartList,VarNum),
   % construct a list of unbound var's
   length(Vars,VarNum),
   % specify their CSP domain
   domain(Vars,0,200),
   %
   % impose the constraints
   %
   % 1.constraint:
   % Vj,p1,p2, if p1 precedes p2, then
   % start(j,p2)>=start(j,p1)+len(j,p1)
   findall((J,P1,P2),precedes(J,P1,P2),PrecList),
   impose_order(PrecList,PartList,Vars),
   % 2.constraint:
   % cumulative(start,len,resources,1)
   get_corresp_values(PartList,part_len,PartLens),
   get_corresp_values(PartList,part_res,ResLens),
   cumulative(Vars,PartLens,ResLens,1),
   % label
   labeling([ ],Vars).
part_res(J,P,1):—job(J),job_part(J,P).
get_var((J,P),PartList,Vars,Var)
   nth(N,PartList,(J,P)),
   nth(N,Vars,Var).
impose_order([(J,P1,P2)|Tail],PartList,Vars)
   get_var((J,P1),PartList,Vars,V1),
   get_var((J,P2),PartList,Vars,V2),
   part_len(J,P1,L1),
   V2#>=V1+L1,
   impose_order(Tail,PartList,Vars).
impose_order([ ],_,_).
get_corresp_values([(J,P)|PartTail],PRED,[Val|ValTail])
   ATOM= . . . [PRED,J,P,Val],
   ATOM,
   get_corresp_values(PartTail,PRED,ValTail).
get_corresp_values([ ],_,[ ]).
   The first two statements indicate that the program will be using pre-defined relations on lists as well as the finite domain solver. The next clause defines the top-level predicate schedule(Vars), which intuitively will return a schedule for the machine. The first atoms in the body of the clause construct a list Vars of unbound variables, one for each job part from the input, and then specify the domain of those variables (viewed as constraint variables). Next, the constraints are defined. It appears that the most convenient way to define a constraint st(j, p₂)≧st(j, p₁)+len(j, p₁) for each precedes(j, p₁, p₂) in the input is to gather a list of such the triples [symbol] j, p₁, p₂ [symbol] satisfying relation precedes and then traverse the list by means of tail recursion, while defining a suitable constraint for each recursion. To do that, relation findall can be used to gather the list, and then call an auxiliary relation implementing the recursion. Next, the lists of lengths of job parts and required resources can be gathered. Particular attention must be paid to the order of the elements in the lists, as they have to match the order of the start times in list Vars. For this, the ordering of the elements in each of those lists is based on the ordering of a “reference” list, obtained by performing findall on relation part_len and gathering all the pairs [symbol] j, p [symbol] . The variables in Vars are assumed to be ordered according to this list, so that, every time one start time needs to be accessed, a call to relation get_var is made, in order to retrieve the variable associated with a given pair [symbol] j, p [symbol] . The construction of the lists of lengths and required resources is implemented by relation get_corresp_values, where the predicate encoding the desired information is reified and passed as an argument. The final step in the clause defining relation schedule includes invoking the constraint solver by means of relation labeling to find a solution to the CSP.

The ASP solution shown above is evidently shorter than the SICStus Prolog version. Those skilled in the art will also readily recognize that the ASP solution is also easier to understand, as the ASP solution does not include rules that explicitly scan lists of variables (in technical terms, the SICStus Prolog version is more procedural). Besides space and clarity considerations, an important advantage of using these embodiments of the present invention over the direct use of SICStus Prolog or a similar system is that the expressive power of ASP has been shown to allow a programmer to encode easily the rules of thumb and common-sense information that often helps efficiently solving reasoning problems.

As stressed above, an advantage of using various embodiments of the present invention over other methods of integrating ASP and constraint solving is the allowance of the use of arbitrary, off-the-shelf answer set solvers and constraint solvers, instead of ad-hoc solvers. This is possible because, in the processes used by various embodiments of the present invention, the two processes of computing the answer sets of the given answer set program (using an answer set solver) and of computing the schedules for the set of constraints included in one of the answer sets (using a constraint solver), can be clearly separated. On the other hand, the other methods of integrating ASP and constraint solving, such as the one described in Veena S. Mellarkod, Michael Gelfond, and Yuanlin Zhang, “Integrating Answer Set Programming and Constraint Logic Programming”, Annals of Mathematics and Artificial Intelligence (2008, to appear), are understood to rely (1) on an interleaved computation of the answer sets and of the solutions to the constraints there included, and (2) on an extended language for the answer set program, where the extensions allow the specification of numerical variables and constraints. As a result of (1), both the answer set solver and the constraint solver must be modified to operate in an interleaved fashion. As a result of (2), the answer set solver must be modified to support the extended syntax. Hence, whereas embodiments of the present intention allow one to arbitrarily select answer set solvers and constraint solvers that work best for the problem to be solved, the other ASP-based techniques discussed above can only rely on the pool of solvers that have been suitably modified. This complicates significantly the use of off-the-shelf solvers, and in particular of commercial solvers. As such solvers are typically recognized to be the fastest available, especially for industrial-size applications, this restriction ultimately causes the performance results for the other ASP-based techniques to be worse than the performance results for our invention.

It is to be understood that the embodiments described above are merely illustrative of the present invention and that many variations of the above-described embodiments can be devised by one skilled in the art without departing from the scope of the invention. It is therefore intended that all such variations be included within the scope of the following claims and their equivalents.

### PARTS LIST

100 system
110 data processing system
120 peripheral system
130 user interface system
140 processor-accessible memory system
S1 step
S2 step
S3 step
S4 step
S5 step
S7 step
S8 step
S9 step
S9-1 step
S9-2 step
S9-3 step
S9-4 step
S9-5 step
S9-6 step
R1 step
R2 step
R3 step
R4 step
R5 step
R6 step
R7 step
R8 step
R9 step
R6-1 step
R6-2 step
R6-3 step
R6-4 step

What is claimed is:

1. A method implemented at least in part by a data processing system, the method for generating job schedules and the method comprising:
generating an answer set at least by executing an answer-set program, the answer set including a set of constraints, and the answer-set program indicating, among other things, a set of jobs;
generating job schedules for the set of jobs at least by executing the answer set or a derivative thereof; and
storing the job schedules in a processor-accessible memory system.

2. The method of claim 1, wherein the answer set is a program suitable for execution by a constraint solver.

3. The method of claim 1, further comprising of generating a constraint program suitable for execution by a constraint solver, the constraint program generated at least from the answer set, and the constraint program being a derivative of the answer set.

4. The method of claim 1, wherein the answer-set program further indicates rules for interactions between jobs and allocation of jobs.

5. The method of claim 1, wherein the answer-set program is executed using at least a set of relations, wherein the set of relations include a relation defining a numerical domain used for solving a scheduling problem involving the set of jobs, a relation listing numerical variables used in solving the scheduling problem, and a relation describing constraints enforced on the numerical variables.

6. The method of claim 3, wherein the constraint solver is a constraint solver embedded in SICStus Prolog.

7. The method of claim 1, wherein the answer-set program indicates a set of offset printing jobs.

8. The method of claim 1, wherein the set of jobs include at least one job part for each job in the set of jobs, and wherein the job schedules indicate an assignment of a start time to each of the job parts, each start time indicating a time on which the job part is to begin being executed by a job-processing resource.

9. The method of claim 1, wherein a plurality of answer sets are generated at least by executing the answer-set program, each answer set including a set of constraints, and wherein the job schedules are generated for the set of jobs at least by executing at least one of the answer sets or derivatives thereof.

10. The method of claim 1, wherein the answer set program is executed by an answer set solver, and wherein the answer set or derivative thereof is executed by a constraint solver.

11. The method of claim 1, wherein the answer set program conforms to basic, non-extended, answer-set programming.

12. A processor-accessible memory system storing instructions configured to cause a data processing system to implement a method for generating job schedules, wherein the instructions comprise:
instructions for generating an answer set at least by executing an answer-set program, the answer set including a set of constraints, and the answer-set program indicating, among other things, a set of jobs;
instructions for generating job schedules for the set of jobs at least by executing the answer set or a derivative thereof; and
instructions for storing the job schedules in a processor-accessible memory system.

13. The system of claim 12, wherein the answer set is a program suitable for execution by a constraint solver.

14. The system of claim 12, further comprising instructions for generating a constraint program suitable for execution by a constraint solver, the constraint program generated at least from the answer set, and the constraint program being a derivative of the answer set.

15. The system of claim 12, wherein the answer-set program further indicates rules for interactions between jobs and allocation of jobs.

16. The system of claim 12, wherein the instructions for generating an answer include instructions for generating a plurality of answer sets at least by executing the answer-set program, each answer set including a set of constraints, and wherein the instructions for generating job schedules include instructions for generating the job schedules for the set of jobs at least by executing at least one of the answer sets or derivatives thereof.

17. The system of claim 12, wherein the instructions for generating an answer set at least by executing an answer-set program are of a format suitable for execution by an answer set solver, and wherein the instructions for generating job schedules at least by executing the answer set or a derivative thereof are of a format suitable for execution by a constraint solver.

18. A system comprising:
a data processing system; and
a memory system communicatively connected to the data processing system and storing instructions configured to cause the data processing system to implement a method for generating job schedules, wherein the instructions comprise:
instructions for generating an answer set at least by executing an answer-set program, the answer set including a set of constraints, and the answer-set program indicating, among other things, a set of jobs;
instructions for generating job schedules for the set of jobs at least by executing the answer set or a derivative thereof; and
instructions for storing the job schedules in a processor-accessible memory system.

19. The system of claim 18, wherein the answer-set program further indicates rules for interactions between jobs and allocation of jobs.

20. The system of claim 18, wherein the instructions for generating an answer set at least by executing an answer-set program are of a format suitable for execution by an answer set solver, and wherein the instructions for generating job schedules at least by executing the answer set or a derivative thereof are of a format suitable for execution by a constraint solver.
